(19) United States
(12) Patent Application Publication
(10) Pub. No.: US 2025/0309799 A1
(43) Pub. Date: Oct. 2, 2025

(54) ELECTRIC APPARATUS AND CONTROL METHOD OF ELECTRIC APPARATUS

(71) Applicant: HONDA MOTOR CO., LTD., Tokyo (JP)

(72) Inventor: Tsunehiro Kobayashi, Wako-shi (JP)

(21) Appl. No.: 19/055,743

(22) Filed: Feb. 18, 2025

(30) Foreign Application Priority Data
Mar. 26, 2024 (JP) 2024-049301

(51) Int. Cl. H02P 7/293; H02J 7/02; H02P 7/03

(52) U.S. Cl. CPC H02P 7/293; H02P 7/04; H02J 7/02; H02P 2207/055

(57) ABSTRACT

An electric apparatus includes: a rotary electric machine; an electric power control unit; and an angle sensor that acquires a phase of a rotor of the rotary electric machine. The electric power control unit sets, based on the phase of the rotor acquired by the angle sensor, a stop phase of the rotor at the time of stopping of the rotary electric machine to an intermediate phase of a backlash provided on a power transmission mechanism connected to the rotor.

### CROSS-REFERENCE TO RELATED APPLICATION

Priority is claimed on Japanese Patent Application No. 2024-049301, filed on Mar. 26, 2024, the contents of which are incorporated herein by reference.

### BACKGROUND

### Field of the Invention

The present invention relates to an electric apparatus and a control method of an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, electric vehicles are known in which, in preparation for starting of traveling of a vehicle in a stop state, by generating a torque for narrowing a gap or looseness provided in a mechanical element such as a backlash of a power transmission mechanism, generation of a mechanical impact sound such as an impact sound of a gear, that is, a so-called tooth striking sound is prevented (for example, refer to Japanese Unexamined Patent Application, First Publication No. 2017-93125).

Further, in the related art, for example, electric vehicles are known in which, when performing AC charging by an external electric power source using a combination of a stator winding of a motor and a bridge circuit, in order to prevent a torque from being generated at the motor, a rotor position (rotation angle) at the time of stopping of the motor is controlled to a predetermined position (for example, refer to Japanese Unexamined Patent Application, First Publication No. 2009-65808).

### SUMMARY

In the technique relating to charging and electric power supply in a mobility on which a secondary battery is mounted, it is a problem to prevent generation of a mechanical impact sound such as an impact sound of a gear caused by a torque generated at the motor at the time of AC charging by the external electric power source, that is, a so-called tooth striking sound. For example, as in the electric vehicles of the related art described above, when the gap provided in the mechanical element is narrowed or even when the torque generated at the motor is minimized, there is a possibility that vibration of the rotor occurs depending on the frequency of a charging current at the time of AC charging, and a mechanical impact sound such as a tooth striking sound of the gear connected to the rotor is generated.

The present application aims at achieving prevention of generation of an impact sound caused by the vibration of a rotor at the time of AC charging. Further, the present application contributes to energy efficiency.

An electric apparatus (for example, an electric apparatus 10 in the embodiment) according to a first aspect of the present invention includes: an electric power storage device (for example, an electric power storage device 11 in the embodiment); a rotary electric machine (for example, a rotary electric machine 16 (M) in the embodiment) having a rotor (for example, a rotor 41 in the embodiment) and a plurality of coils (for example, an α-phase first coil 23 (α1), an α-phase second coil 24 (α2), a β-phase first coil 33 (β1), and a β-phase second coil 34 (β2) in the embodiment); an electric power control unit (for example, an electric power control unit 10a in the embodiment) that is connected to the electric power storage device and one or more of the plurality of coils and controls electric power transfer of each of the electric power storage device and the rotary electric machine; an electric power source connection member (for example, an AC electric power source connection portion 15 in the embodiment) that connects the electric power control unit and the one or more of the plurality of coils to an external AC electric power source; and a phase acquisition portion (for example, an angle sensor 52 in the embodiment) that acquires a phase (for example, a phase θ in the embodiment) of the rotor, wherein the electric power control unit sets, based on the phase of the rotor acquired by the phase acquisition portion, a stop phase (for example, a target phase θ0 in the embodiment) of the rotor at a time of stopping of the rotary electric machine to an intermediate phase (for example, (θ1+θ2)/2 in the embodiment) of a backlash provided on a power transmission mechanism (for example, a power transmission mechanism 53 in the embodiment) connected to the rotor.

A second aspect is the electric apparatus according to the first aspect described above which may include: a state amount acquisition portion (for example, a current sensor 51 in the embodiment) that acquires a state amount relating to a current which flows through the coil, wherein the electric power control unit may acquire the intermediate phase by a first phase (for example, an advance angle side threshold phase θ1 in the embodiment) of the rotor acquired by the phase acquisition portion when the state amount acquired by the state amount acquisition portion at an advance angle side of the rotor becomes a predetermined state, and a second phase (for example, a retard angle side threshold phase θ2 in the embodiment) of the rotor acquired by the phase acquisition portion when the state amount acquired by the state amount acquisition portion at a retard angle side of the rotor becomes the predetermined state.

A third aspect is the electric apparatus according to the first or second aspect described above which may include: a regulation mechanism (for example, a regulation mechanism 54 in the embodiment) that regulates power transmission by the power transmission mechanism, wherein the electric power control unit may set the stop phase to the intermediate phase at a time of operation of the regulation mechanism.

An electric apparatus control method according to a fourth aspect of the present invention is a control method of an electric apparatus that includes: an electric power storage device (for example, an electric power storage device 11 in the embodiment); a rotary electric machine (for example, a rotary electric machine 16 (M) in the embodiment) having a rotor (for example, a rotor 41 in the embodiment) and a plurality of coils (for example, an α-phase first coil 23 (α1), an α-phase second coil 24 (α2), a β-phase first coil 33 (β1), and a β-phase second coil 34 (β2) in the embodiment); an electric power control unit (for example, an electric power control unit 10a in the embodiment) that is connected to the electric power storage device and one or more of the plurality of coils and controls electric power transfer of each of the electric power storage device and the rotary electric machine; an electric power source connection member (for example, an AC electric power source connection portion 15 in the embodiment) that connects the electric power control unit and the one or more of the plurality of coils to an external AC electric power source; and a phase acquisition portion (for example, an angle sensor 52 in the embodiment) that acquires a phase of the rotor, the electric apparatus control method including: a step (Step S05) of, before electric power is supplied via the electric power source connection member from the external AC electric power source, based on the phase of the rotor acquired by the phase acquisition portion, setting a stop phase (for example, a target phase θ0 in the embodiment) of the rotor at a time of stopping of the rotary electric machine to an intermediate phase (for example, (θ1+θ2)/2 in the embodiment) of a backlash provided on a power transmission mechanism (for example, a power transmission mechanism 53 in the embodiment) connected to the rotor.

According to the first aspect described above, by setting the stop phase of the rotor to the intermediate phase of the backlash, even when positive and negative torques are generated at the rotor in a state where an AC current is supplied to the coil of the rotary electric machine, it is possible to prevent a gap provided in a mechanical element from being narrowed and prevent generation of an impact sound such as a tooth striking sound of a gear in the power transmission mechanism.

In the case of the second aspect described above, for example, in response to an increase of a current or the like when a gap provided in a mechanical element is narrowed in accordance with the normal rotation or the reverse rotation of the rotary electric machine, the first phase and the second phase on the advance angle side and the retard angle side of the rotor can be acquired with high accuracy, and it is possible to easily acquire an adequate intermediate phase in accordance with the first phase and the second phase.

In the case of the third aspect described above, by including the regulation mechanism, when the first phase and the second phase on the advance angle side and the retard angle side of the rotor are acquired, it is possible to prevent generation of rotation at the power transmission mechanism connected to the rotor. For example, when the power transmission mechanism mounted on a vehicle is connected to a wheel, by regulating the rotation of the wheel, it is possible to acquire the first phase and the second phase on the advance angle side and the retard angle side of the rotor with high accuracy.

According to the fourth aspect described above, by setting the stop phase of the rotor to the intermediate phase of the backlash, even when positive and negative torques are generated at the rotor in a state where an AC current is supplied to the coil of the rotary electric machine, it is possible to prevent a gap provided in a mechanical element from being narrowed and prevent generation of an impact sound such as a tooth striking sound of a gear in the power transmission mechanism.

### BRIEF DESCRIPTION OF THE DRAWINGS

FIG. 1 is a view showing the configuration of an electric apparatus of an embodiment of the present invention.

FIG. 2 is a configuration view of each full-bridge circuit and a rotary electric machine in the electric apparatus of the embodiment of the present invention.

FIG. 3 is a view showing a configuration of part of the electric apparatus of the embodiment of the present invention.

FIG. 4 is a flowchart showing an operation of the electric apparatus of the embodiment of the present invention.

FIG. 5 is a view showing an example of a change of a rotor phase and a motor current in accordance with normal rotation and reverse rotation of a rotary electric machine before AC charging is started in the electric apparatus of the embodiment of the present invention.

FIG. 6 is a configuration view of a rotary electric machine of an electric apparatus in a modification example of the embodiment of the present invention.

### DESCRIPTION OF EMBODIMENTS

Hereinafter, an electric apparatus according to an embodiment of the present invention will be described with reference to the accompanying drawings.

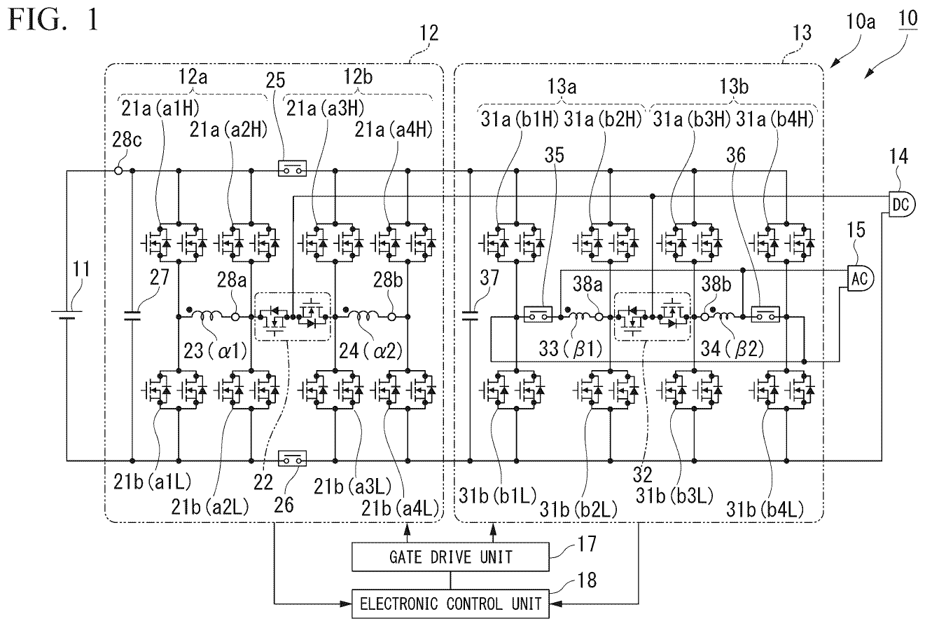

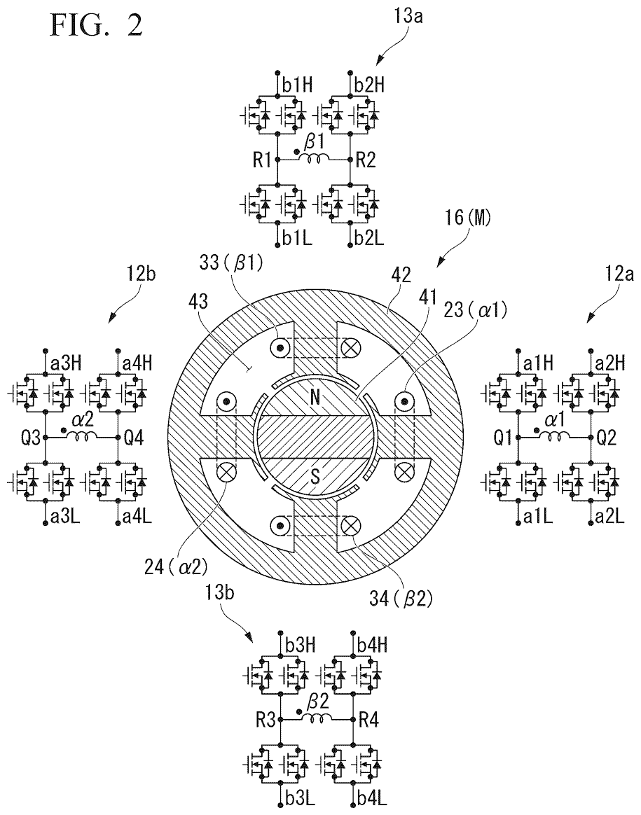

FIG. 1 is a view showing the configuration of an electric apparatus 10 of an embodiment. FIG. 2 is a configuration view of full-bridge circuits 12a, 12b, 13a, 13b and a rotary electric machine 16 in the electric apparatus 10 of the embodiment.

The electric apparatus 10 of the embodiment is mounted, for example, on an electric vehicle, an electric movable body, an electric machine, an electric power source apparatus, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like. The electric machine is, for example, a construction machinery that includes a rotary electric machine as a power source and the like. The electric power source apparatus is, for example, a stationary or mobile electric power source apparatus that performs discharging and charging of an electric power storage device and the like.

### (Electric Apparatus)

As shown in FIG. 1 and FIG. 2, the electric apparatus 10 of the embodiment includes, for example, an electric power storage device 11, a first electric power conversion portion 12, a second electric power conversion portion 13, a DC electric power source connection portion 14, an AC electric power source connection portion 15 (electric power source connection member), a rotary electric machine 16 (M), a gate drive unit 17, and an electronic control unit 18. For example, the first electric power conversion portion 12, the second electric power conversion portion 13, the DC electric power source connection portion 14, the AC electric power source connection portion 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging. The electric power storage device 11 transfers electric power to and from the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a and a second full-bridge circuit 12b.

Each of the first full-bridge circuit 12a and the second full-bridge circuit 12b includes, for example, a so-called H-bridge circuit formed of a plurality of switching elements connected in two phases by bridge connection. Each switching element is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element is, for example, an N-channel type MOSFET.

The plurality of switching elements are, for example, a pair of transistors forming each of high-side arm and low-side arm element portions 21a, 21b that form a pair in each phase. Each pair of transistors of each element portion 21a, 21b is a pair of transistors that are connected, for example, in parallel.

Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 connected between neutral points Q2, Q3 of the first full-bridge circuit 12a and the second full-bridge circuit 12b. The neutral point Q2 of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the neutral point Q2 is a connection point between a source of the high-side arm element portion 21a (a2H) and a drain of the low-side arm element portion 21b (a2L). The neutral point Q3 of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the neutral point Q3 is a connection point between a source of the high-side arm element portion 21a (a3H) and a drain of the low-side arm element portion 21b (a3L).

The first switch 22 is, for example, a bidirectional switch formed of two switching elements. Each switching element is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the neutral points Q2, Q3 by ON (conduction)/OFF (cutoff) of the two transistors.

Each transistor may include a rectifier element such as a reflux diode which is connected in parallel between a collector and an emitter in a forward direction toward the collector from the emitter.

The first electric power conversion portion 12 is connected to an α-phase first coil 23 (α1) and an α-phase second coil 24 (α2) of the rotary electric machine 16 described later. The α-phase first coil 23 is connected between neutral points Q1, Q2 of the first full-bridge circuit 12a. The α-phase second coil 24 (α2) is connected between neutral points Q3, Q4 of the second full-bridge circuit 12b. The neutral point Q1 of the first full-bridge circuit 12a is, for example, a connection point between a high-side arm element portion 21a (a1H) and a low-side arm element portion 21b (a1L) that are connected in series in the first phase of the first full-bridge circuit 12a. For example, the neutral point Q1 is a connection point between a source of the high-side arm element portion 21a (a1H) and a drain of the low-side arm element portion 21b (a1L). The neutral point Q4 of the second full-bridge circuit 12b is, for example, a connection point between a high-side arm element portion 21a (a4H) and a low-side arm element portion 21b (a4L) that are connected in series in the second phase of the second full-bridge circuit 12b. For example, the neutral point Q4 is a connection point between a source of the high-side arm element portion 21a (a4H) and a drain of the low-side arm element portion 21b (a4L).

The first electric power conversion portion 12 includes a first connection-disconnection device 25 connected between positive electrodes of the first full-bridge circuit 12a and the second full-bridge circuit 12b and a second connection-disconnection device 26 connected between negative electrodes of the first full-bridge circuit 12a and the second full-bridge circuit 12b.

Each of the first connection-disconnection device 25 and the second connection-disconnection device 26 is, for example, a contactor and switches between ON (conduction) and OFF (cutoff) of the connection between the first full-bridge circuit 12a and the second full-bridge circuit 12b.

The first electric power conversion portion 12 includes, for example, a capacitor (condenser) 27 connected between the positive electrode and the negative electrode. For example, the capacitor 27 smooths voltage variation generated in accordance with a switching operation between ON (conduction) and OFF (cutoff) of each switching element of the first electric power conversion portion 12.

The first electric power conversion portion 12 includes, for example, a first current sensor 28a arranged between the α-phase first coil 23 (α1) and the neutral point Q2, a second current sensor 28b arranged between the α-phase second coil 24 (α2) and the neutral point Q4, and a third current sensor 28c arranged between the electric power storage device 11 and the first electric power conversion portion 12.

For example, the first current sensor 28a detects a current that flows through the α-phase first coil 23 (α1). The second current sensor 28b detects a current that flows through the α-phase second coil 24 (α2).

The third current sensor 28c detects a current that flows between the first electric power conversion portion 12 and the electric power storage device 11.

The second electric power conversion portion 13 includes a third full-bridge circuit 13a and a fourth full-bridge circuit 13b.

Each of the third full-bridge circuit 13a and the fourth full-bridge circuit 13b includes, for example, a so-called H-bridge circuit formed of a plurality of switching elements connected in two phases by bridge connection. Each switching element is, for example, a transistor of a SiC or the like, such as a MOSFET or an IGBT. Each switching element is, for example, an N-channel type MOSFET.

The plurality of switching elements are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 connected between neutral points R2, R3 of the third full-bridge circuit 13a and the fourth full-bridge circuit 13b. The neutral point R2 of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the neutral point R2 is a connection point between a source of the high-side arm element portion 31a (b2H) and a drain of the low-side arm element portion 31b (b2L). The neutral point R3 of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the neutral point R3 is a connection point between a source of the high-side arm element portion 31a (b3H) and a drain of the low-side arm element portion 31b (b3L).

The second switch 32 is, for example, a bidirectional switch formed of two switching elements. Each switching element is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the neutral points R2, R3 by ON (conduction)/OFF (cutoff) of the two transistors.

Each transistor may include a rectifier element such as a reflux diode which is connected in parallel between a collector and an emitter in a forward direction toward the collector from the emitter.

The second electric power conversion portion 13 is connected to a β-phase first coil 33 (β1) and a β-phase second coil 34 (β2) of the rotary electric machine 16 described later. The β-phase first coil 33 is connected between neutral points R1, R2 of the third full-bridge circuit 13a. The β-phase second coil 34 (β2) is connected between neutral points R3, R4 of the fourth full-bridge circuit 13b. The neutral point R1 of the third full-bridge circuit 13a is, for example, a connection point between a high-side arm element portion 31a (b1H) and a low-side arm element portion 31b (b1L) that are connected in series in the first phase of the third full-bridge circuit 13a. For example, the neutral point R1 is a connection point between a source of the high-side arm element portion 31a (b1H) and a drain of the low-side arm element portion 31b (b1L). The neutral point R4 of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the neutral point R4 is a connection point between a source of the high-side arm element portion 31a (b4H) and a drain of the low-side arm element portion 31b (b4L).

The second electric power conversion portion 13 includes a third connection-disconnection device 35 connected between one end of the β-phase first coil 33 (β1) and the third full-bridge circuit 13a and a fourth connection-disconnection device 36 connected between one end of the β-phase second coil 34 (β2) and the fourth full-bridge circuit 13b.

Each of the third connection-disconnection device 35 and the fourth connection-disconnection device 36 is, for example, a contactor. The third connection-disconnection device 35 is connected, for example, between the one end of the β-phase first coil 33 (β1) and the neutral point R1 of the first phase of the third full-bridge circuit 13a and switches between ON (conduction) and OFF (cutoff) of the connection between the β-phase first coil 33 (β1) and the neutral point R1. The fourth connection-disconnection device 36 is connected, for example, between the one end of the β-phase second coil 34 (β2) and the neutral point R4 of the second phase of the fourth full-bridge circuit 13b and switches between ON (conduction) and OFF (cutoff) of the connection between the β-phase second coil 34 (β2) and the neutral point R4.

The second electric power conversion portion 13 includes, for example, a capacitor (condenser) 37 connected between the positive electrode and the negative electrode. For example, the capacitor 37 smooths voltage variation generated in accordance with a switching operation between ON (conduction) and OFF (cutoff) of each switching element of the second electric power conversion portion 13.

The second electric power conversion portion 13 includes, for example, a fourth current sensor 38a arranged between the β-phase first coil 33 (β1) and the neutral point R2 and a fifth current sensor 38b arranged between the β-phase second coil 34 (β2) and the neutral point R4.

For example, the fourth current sensor 38a detects a current that flows through the β-phase first coil 33 (β1). The fifth current sensor 38b detects a current that flows through the β-phase second coil 34 (β2).

The DC electric power source connection portion 14 and the AC electric power source connection portion 15 include, for example, a connection device (connector) or the like for DC electric power and for AC electric power of a predetermined standard. The DC electric power source connection portion 14 and the AC electric power source connection portion 15 are connected, for example, to a DC electric power source (external DC electric power source) and an AC electric power source (external AC electric power source) at the outside on the basis of a commercial electric power source or the like connected to an electric power system.

The DC electric power source connection portion 14 is connected, for example, to the negative electrode of the second electric power conversion portion 13 and to a neutral point (that is, a point between the two transistors connected reversely in series) of each of the first switch 22 and the second switch 32.

The AC electric power source connection portion 15 is connected, for example, to each of the first neutral point R1 and the fourth neutral point R4 of the second electric power conversion portion 13 and to the connection point between the β-phase first coil 33 (β1) and the third connection-disconnection device 35.

The rotary electric machine 16 (M) is, for example, a two-phase AC brushless DC motor. The rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42.

The rotor 41 includes a field permanent magnet. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the different teeth of the stator core 42 in the same direction when seen from an axis line direction along a center axis of the rotary electric machine 16 (M). The α-phase first coil 23 (α1) and the α-phase second coil 24 (α2) are arranged, for example, so as to share part of a slot 43 formed in the stator core 42 and are magnetically coupled to each other in the same polarity.

The β-phase first coil 33 (β1) and the β-phase second coil 34 (β2) set, for example, a spatial phase difference from each other to be zero and are wound with respect to the different teeth of the stator core 42 in the same direction when seen from the axis line direction along the center axis of the rotary electric machine 16 (M). The β-phase first coil 33 (β1) and the β-phase second coil 34 (β2) are arranged, for example, so as to share part of the slot 43 formed in the stator core 42 and are magnetically coupled to each other in the same polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°.

For example, each coil α1, α2, β1, β2 is attached to the stator core 42 by concentrated winding, distributed winding, or the like, and the coils α1, α2, β1, β2 have the same number of winding as one another.

The rotary electric machine 16 (M) generates rotation power by performing a power running operation using electric power supplied from the first electric power conversion portion 12 and the second electric power conversion portion 13. For example, when the rotary electric machine 16 (M) is connected to a wheel of the vehicle, the rotary electric machine 16 (M) generates a travel drive force by the electric power supplied from the first electric power conversion portion 12 and the second electric power conversion portion 13. The rotary electric machine 16 (M) may generate electric power by performing a regeneration operation using rotation power input from the wheel side of the vehicle. For example, when the rotary electric machine 16 (M) is connected to the internal combustion engine of the vehicle, the rotary electric machine 16 (M) may generate electric power using the power of the internal combustion engine.

The gate drive unit 17 switches between ON (conduction) and OFF (cutoff) of each connection-disconnection device 25, 26, 35, 36 and each switching element of the first electric power conversion portion 12 and the second electric power conversion portion 13 on the basis of a control signal received from the electronic control unit 18. For example, the gate drive unit 17 switches between ON (conduction) and OFF (cutoff) of each switching element of each full-bridge circuit 12a, 12b, 13a, 13b by outputting a gate signal generated by amplification, level shift, and the like of the control signal.

The electronic control unit 18 integrally controls an operation of each of the electric power control unit 10a and the rotary electric machine 16 (M). For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as an LSI (Large Scale Integration).

The electronic control unit 18 generates a control signal indicating a timing when each connection-disconnection device 25, 26, 35, 36 and each switching element of the first electric power conversion portion 12 and the second electric power conversion portion 13 are driven to ON (conduction) and OFF (cutoff). The electronic control unit 18 inputs the generated control signal to the gate drive unit 17.

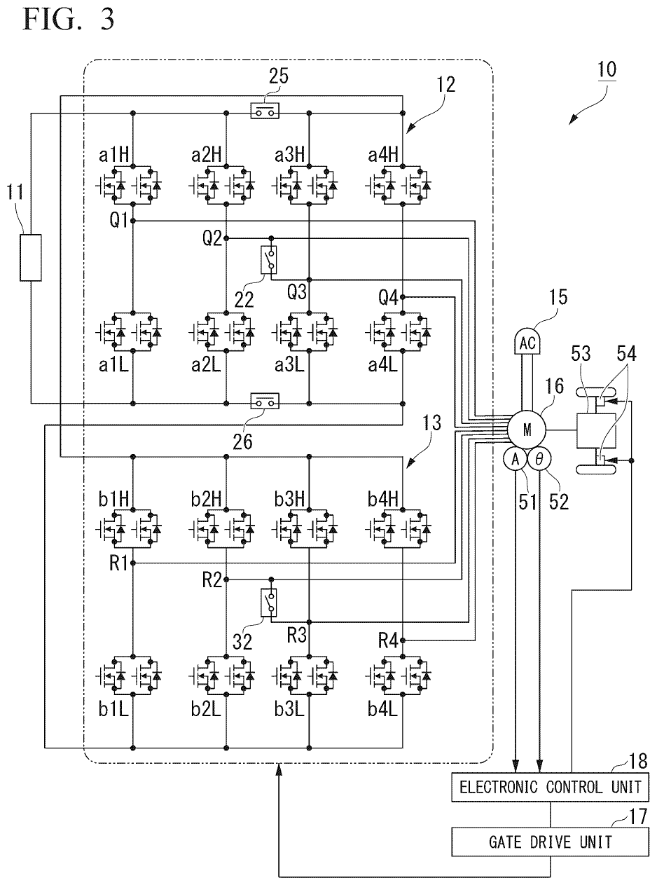

FIG. 3 is a view showing a configuration of part of the electric apparatus 10 of the embodiment.

As shown in FIG. 1, FIG. 2, and FIG. 3, the electric apparatus 10 includes, for example, a current sensor 51 (state amount acquisition portion), an angle sensor 52 (phase acquisition portion), a power transmission mechanism 53, and a regulation mechanism 54. The current sensor 51 detects a current (motor current) that flows through each coil α1, α2, β1, β2 of the rotary electric machine 16 (M). The angle sensor 52 detects a phase (rotation angle) θ of the rotor 41 of the rotary electric machine 16 (M). A signal of a detection value that is output from each of the current sensor 51 and the angle sensor 52 is input to the electronic control unit 18. The power transmission mechanism 53 is connected to the rotor 41. The power transmission mechanism 53 includes, for example, a device element such as a gear, a belt, and a chain. The power transmission mechanism 53 transmits power, for example, between the rotary electric machine 16 (M) and the wheel of the vehicle. The regulation mechanism 54 regulates power transmission by the power transmission mechanism 53. The regulation mechanism 54 is, for example, an electric parking brake, a parking lock mechanism, and the like that stop the rotation of a drive shaft or the wheel that is connected to the power transmission mechanism 53 in the vehicle.

### (Control Operation of Electric Apparatus)

The electronic control unit 18 sets the first connection-disconnection device 25 and the second connection-disconnection device 26 to an ON (conduction) state in the case of the power running operation or the regeneration operation of the rotary electric machine 16 (M). The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by the switching between ON (conduction) and OFF (cutoff) of the first switch 22 and the second switch 32.

The electronic control unit 18 performs, for example, a feedback control or the like of a current in which a current detection value of the rotary electric machine 16 (M) and a current target value in response to a torque command value of the rotary electric machine 16 (M) are used and generates a control signal that commands the driving of each switching element of the first electric power conversion portion 12 and the second electric power conversion portion 13.

At the time of DC charging, that is, when the electric power storage device 11 is charged by the external DC electric power source connected to the DC electric power source connection portion 14, the electronic control unit 18 sets the first connection-disconnection device 25 and the second connection-disconnection device 26 to be in an ON (conduction) state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electric power storage device 11.

At the time of AC charging, that is, when the electric power storage device 11 is charged by the external AC electric power source connected to the AC electric power source connection portion 15, the electronic control unit 18 sets the first connection-disconnection device 25 and the second connection-disconnection device 26 to be in an OFF (cutoff) state for insulation.

The electronic control unit 18 sets, for example, the α-phase first coil 23 (α1) and the α-phase second coil 24 (α2) that are magnetically coupled to each other in the same polarity to be a coil of a DC conversion phase (α phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the same polarity to be a coil of an AC input phase (β phase) connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of the same conductivity type which are connected (totem pole connection) in series in the same direction. The electronic control unit 18 performs the power factor correction of an input voltage Vac and an input current Iac while performing rectification of AC electric power received from the external AC electric power source into DC electric power and increasing the voltage, for example, by controlling the switching of each switching element in each full-bridge circuit 13a, 13b of the second electric power conversion portion 13.

The electronic control unit 18 sets a stop phase of the rotor 41 at the time of stopping of the rotary electric machine 16 to an intermediate phase of a backlash provided on the power transmission mechanism 53 connected to the rotor 41 before AC charging is started, for example, on the basis of the motor current and the phase θ of the rotor 41 acquired by the current sensor 51 and the angle sensor 52.

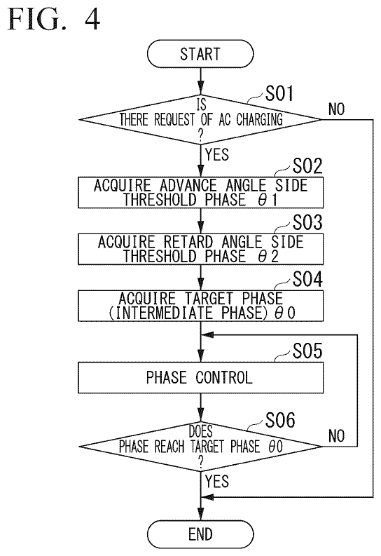

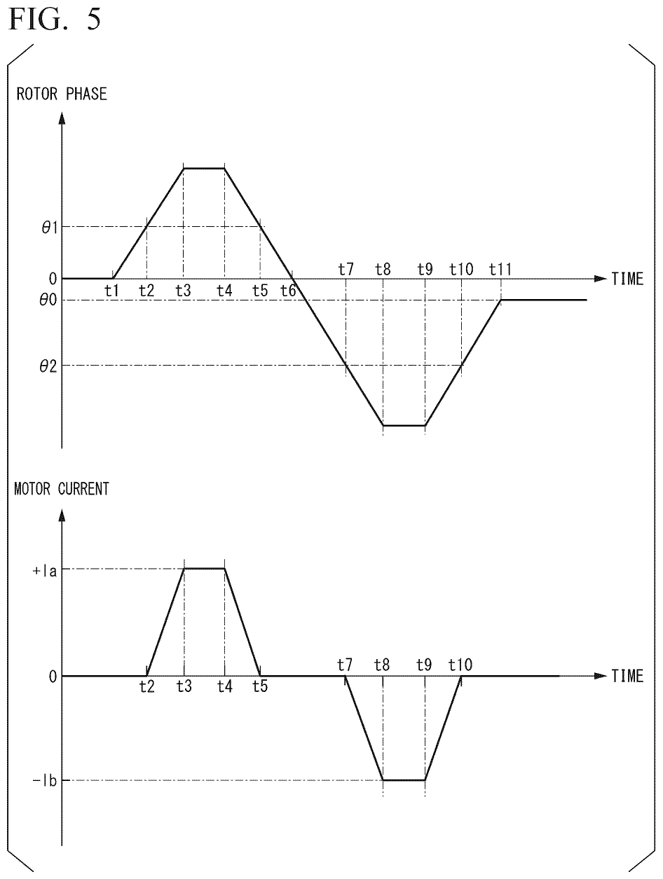

FIG. 4 is a flowchart showing an operation of the electric apparatus 10 of the embodiment. FIG. 5 is a view showing an example of a change of a rotor phase and a motor current in accordance with normal rotation and reverse rotation of the rotary electric machine 16 before AC charging is started in the electric apparatus 10 of the embodiment.

First, in the Step S01 shown in FIG. 4, the electronic control unit 18 determines whether or not there is a request of AC charging in which the electric power storage device 11 is charged by the external AC electric power source. When the determination result is “NO”, the electronic control unit 18 advances the process to the end. On the other hand, when the determination result is “YES”, the electronic control unit 18 advances the process to Step S02.

Next, in Step S02, the electronic control unit 18 regulates power transmission of the power transmission mechanism 53 by the regulation mechanism 54 before the AC charging is started. The electronic control unit 18 rotates the rotary electric machine 16 normally by the electric power supplied from the electric power storage device 11 and shifts the phase θ of the rotor 41 to an advance angle side, for example, as a time t1 or later shown in FIG. 5. The zero point of the rotor phase shown in FIG. 5 is a relative reference phase and is an appropriate initial phase. The electronic control unit 18 sets the phase θ of the rotor 41 acquired by the angle sensor 52 to an advance angle side threshold phase θ1 (first phase), for example, when the motor current starts to increase from zero toward a predetermined high-side threshold current +Ia in accordance with a torsional stiffness or the like in the power transmission mechanism 53 (or between the rotary electric machine 16 and the wheel or the like) as a time t2 shown in FIG. 5. The electronic control unit 18 rotates the rotary electric machine 16 reversely, for example, after a time t4 from a time t3 when the motor current reaches the predetermined high-side threshold current +Ia. The electronic control unit 18 may set the phase θ of the rotor 41 acquired by the angle sensor 52 to the advance angle side threshold phase θ1, for example, when the motor current that is reduced from the predetermined high-side threshold current +Ia reaches zero as a time t5 shown in FIG. 5.

Next, in Step S03, the electronic control unit 18 shifts the phase θ of the rotor 41 to an advance angle side, for example, as a time t6 or later shown in FIG. 5 by the reverse rotation of the rotary electric machine 16 while maintaining the regulation of power transmission by the regulation mechanism 54. The electronic control unit 18 sets the phase θ of the rotor 41 acquired by the angle sensor 52 to a retard angle side threshold phase θ2 (second phase), for example, when the motor current starts to decrease from zero toward a predetermined low-side threshold current −Ib in accordance with a torsional stiffness or the like in the power transmission mechanism 53 (or between the rotary electric machine 16 and the wheel or the like) as a time t7 shown in FIG. 5. The electronic control unit 18 rotates the rotary electric machine 16 normally, for example, after a time t9 from a time t8 when the motor current reaches the predetermined low-side threshold current −Ib. The electronic control unit 18 may set the phase θ of the rotor 41 acquired by the angle sensor 52 to the retard angle side threshold phase θ2, for example, when the motor current that is increased from the predetermined low-side threshold current −Ib reaches zero as a time t10 shown in FIG. 5.

Next, in Step S04, the electronic control unit 18 acquires a target phase θ0, for example, after performing each process (Step S02 and Step S03) described above that acquires each of the advance angle side threshold phase θ1 and the retard angle side threshold phase θ2 over predetermined times of one or more times. The electronic control unit 18 sets an intermediate phase (=(θ1+θ2)/2) of the advance angle side threshold phase θ1 and the retard angle side threshold phase θ2 to the target phase θ0 theta 0, for example, as a time t11 shown in FIG. 5.

Next, in Step S05, the electronic control unit 18 performs a phase control that sets the stop phase of the rotor 41 to the target phase θ0 by the rotation of the rotary electric machine 16.

Next, in Step S06, the electronic control unit 18 determines whether or not the stop phase of the rotor 41 reaches the target phase θ0. When the determination result is “NO”, the electronic control unit 18 repeats the process of Step S05. On the other hand, when the determination result is “YES”, the electronic control unit 18 advances the process to the end.

As described above, according to the electric apparatus 10 of the embodiment, by setting the stop phase (target phase θ0) of the rotor 41 to the intermediate phase (=(θ1+θ2)/2) of the backlash, it is possible to prevent generation of an impact sound such as a tooth striking sound of a gear in the power transmission mechanism 53. Even when positive and negative torques are generated at the rotor 41 in a state where an AC current is supplied to each coil β1, β2 of the rotary electric machine 16 (M), it is possible to prevent a gap provided in a mechanical element from being narrowed.

For example, in response to an increase of a motor current or the like when a gap provided in a mechanical element is narrowed in accordance with the normal rotation or the reverse rotation of the rotary electric machine 16 (M), the advance angle side threshold phase θ1 and the retard angle side threshold phase θ2 of the rotor 41 can be acquired with high accuracy, and it is possible to easily acquire the adequate intermediate phase (=(θ1+θ2)/2) in accordance with the phases θ1, θ2.

By including the regulation mechanism 54, when the advance angle side threshold phase θ1 and the retard angle side threshold phase θ2 of the rotor 41 are acquired, it is possible to prevent generation of rotation at the power transmission mechanism 53 connected to the rotor 41. For example, when the power transmission mechanism 53 mounted on a vehicle is connected to a wheel, by regulating the rotation of the wheel, it is possible to acquire the advance angle side threshold phase θ1 and the retard angle side threshold phase θ2 of the rotor 41 with high accuracy.

### Modification Example

Hereinafter, modification examples of the embodiment will be described. The same parts as those of the above-described embodiment are denoted by the same reference numerals, and descriptions thereof are omitted or simplified.

The above embodiment is described using an example in which the electronic control unit 18 sets the stop phase of the rotor 41, for example, on the basis of the motor current acquired by the current sensor 51; however, the embodiment is not limited thereto. For example, the electronic control unit 18 may include an appropriate sensor that acquires an output, a torque, or the like of the rotary electric machine 16 (M) instead of the current sensor 51. The electronic control unit 18 may set the stop phase of the rotor 41 on the basis of another state amount relating to the motor current such as the output or the torque of the rotary electric machine 16 (M) instead of the motor current.

The above embodiment is described using an example in which each of the α-phase first coil 23 (α1), the α-phase second coil 24 (α2), the β-phase first coil 33 (β1), and the β-phase second coil 34 (β2) is wound around the different teeth of the stator core 42; however, the embodiment is not limited thereto.

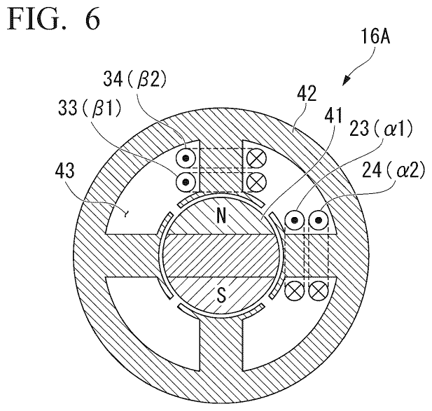

FIG. 6 is a configuration view of a rotary electric machine 16A of the electric apparatus 10 in a modification example of the embodiment.

As shown in FIG. 6, the α-phase first coil 23 (α1) and the α-phase second coil 24 (α2) may be wound around the same teeth of the stator core 42, and the β-phase first coil 33 (β1) and the β-phase second coil 34 (β2) may be wound around the same teeth of the stator core 42.

The above embodiment is described using an example in which the β-phase first coil 33 (β1) and the β-phase second coil 34 (β2) are magnetically coupled to each other in the same polarity; however, the embodiment is not limited thereto. The β-phase first coil 33 (β1) and the β-phase second coil 34 (β2) may be magnetically coupled to each other in an opposite polarity. In this case, for example, a connection-disconnection device connected between one end of the β-phase first coil 33 (β1) and the neutral point R2 of the second phase of the third full-bridge circuit 13a or a connection-disconnection device connected between one end of the β-phase second coil 34 (β2) and the neutral point R3 of the first phase of the fourth full-bridge circuit 13b may be provided.

The above embodiment is described using an example in which at the time of AC charging, the current flows from the external AC electric power source to the β-phase first coil 33 (β1) and the β-phase second coil 34 (β2); however, the embodiment is not limited thereto. For example, at least one of a connection-disconnection device that switches between ON (conduction) and OFF (cutoff) of the connection between the AC electric power source connection portion 15 and the β-phase first coil 33 (β1) and a connection-disconnection device that switches between ON (conduction) and OFF (cutoff) of the connection between the AC electric power source connection portion 15 and the β-phase second coil 34 (β2) may be provided. In this case, a current may be set to flow only through the β-phase first coil 33 (β1) or the β-phase second coil 34 (β2).

The above embodiment is described using an example in which, as a parallel pattern, the DC electric power source connection portion 14 is connected to the negative electrode of the second electric power conversion portion 13 and to the neutral point (that is, between the two transistors connected reversely in series) of each of the first switch 22 and the second switch 32; however, the embodiment is not limited thereto. For example, as a serial pattern, the DC electric power source connection portion 14 may be connected to the negative electrode of the second electric power conversion portion 13 and to the neutral point Q4 of the first electric power conversion portion 12 and the neutral point R4 of the second electric power conversion portion 13. For example, as another parallel pattern, the DC electric power source connection portion 14 may be connected to the negative electrode of the second electric power conversion portion 13 and to the neutral points Q2, Q4 of the first electric power conversion portion 12 and the neutral points R2, R4 of the second electric power conversion portion 13.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine having a rotor and a plurality of coils;
an electric power control unit that is connected to the electric power storage device and one or more of the plurality of coils and controls electric power transfer of each of the electric power storage device and the rotary electric machine;
an electric power source connection member that connects the electric power control unit and the one or more of the plurality of coils to an external AC electric power source; and
a phase acquisition portion that acquires a phase of the rotor,
wherein the electric power control unit sets, based on the phase of the rotor acquired by the phase acquisition portion, a stop phase of the rotor at a time of stopping of the rotary electric machine to an intermediate phase of a backlash provided on a power transmission mechanism connected to the rotor.

2. The electric apparatus according to claim 1, comprising:
a state amount acquisition portion that acquires a state amount relating to a current which flows through the coil,
wherein the electric power control unit acquires the intermediate phase by
a first phase of the rotor acquired by the phase acquisition portion when the state amount acquired by the state amount acquisition portion at an advance angle side of the rotor becomes a predetermined state, and
a second phase of the rotor acquired by the phase acquisition portion when the state amount acquired by the state amount acquisition portion at a retard angle side of the rotor becomes the predetermined state.

3. The electric apparatus according to claim 1, comprising:
a regulation mechanism that regulates power transmission by the power transmission mechanism,
wherein the electric power control unit sets the stop phase to the intermediate phase at a time of operation of the regulation mechanism.

4. The electric apparatus according to claim 2, comprising:
a regulation mechanism that regulates power transmission by the power transmission mechanism,
wherein the electric power control unit sets the stop phase to the intermediate phase at a time of operation of the regulation mechanism.

5. An electric apparatus control method which is a control method of an electric apparatus comprising:
an electric power storage device;
a rotary electric machine having a rotor and a plurality of coils;
an electric power control unit that is connected to the electric power storage device and one or more of the plurality of coils and controls electric power transfer of each of the electric power storage device and the rotary electric machine;
an electric power source connection member that connects the electric power control unit and the one or more of the plurality of coils to an external AC electric power source; and
a phase acquisition portion that acquires a phase of the rotor, the electric apparatus control method including:
before electric power is supplied via the electric power source connection member from the external AC electric power source,
based on the phase of the rotor acquired by the phase acquisition portion, setting a stop phase of the rotor at a time of stopping of the rotary electric machine to an intermediate phase of a backlash provided on a power transmission mechanism connected to the rotor.
